(19) United States
(12) Patent Application Publication
(10) Pub. No.: US 2008/0302342 A1
(43) Pub. Date: Dec. 11, 2008

(54) Method of fuel conversion for engine and an apparatus of the same

(76) Inventor: Horng Jiang, Xindian (TW)

Correspondence Address: BIRCH STEWART KOLASCH & BIRCH, PO BOX 747, FALLS CHURCH, VA, 22040-0747, US

(21) Appl. No.: 11/808,210

(22) Filed: Jun. 7, 2007

(51) Int. Cl. F02B 47/02; C10L 1/04

(52) U.S. Cl. 123/536; 123/25 A

(57) ABSTRACT

A method and an apparatus of fuel conversion for engine substantially provide a controller to receive either a signal for actuating the injection fuel nozzle to supply fuel or a signal of a central controller so as to actuate a high voltage generator. The high voltage generator generates a high voltage to boost a high power component of an energy converter. The high power component generates a high energy to ionize the passing fuel mixture into hydrogen and C1˜C4 hydrocarbon combustible gas mixture and feeds into engine chamber to achieve the effect of saving fuel by reducing fuel loss and enhancing engine power.

### FIELD OF THE INVENTION

The present invention relates to a method and an apparatus of fuel conversion for engine. It provides a controller to receive either a signal for actuating the injection fuel nozzle to supply fuel or a signal of a central controller so as to actuate a high voltage generator. The high voltage generator generates a high voltage to boost a high power component of an energy converter. The high power component generates a high energy to ionize the passing fuel mixture into hydrogen and C1˜C4 hydrocarbon combustible gas mixture and feeds into engine chamber. It will reduce fuel loss and enhance engine power to achieve the effect of saving fuel.

### BACKGROUND OF THE INVENTION

The operation of conventional engine system is to pressurize the gasoline or diesel by passing through a fuel pump. Through the injection fuel nozzle (which is mounted on the end of engine) the fuel is nebulized to enter engine chamber and mixed with air. By means of sparking plug the fuel mixture is ignited to burn and generate power.

To achieve the goal of saving fuel, conventional technology is improved in two ways. The first is to control the fuel injection amount of injection fuel nozzle electronically. It is so called electronic fuel injection supplying engine. The other is to ignite sooner by reinforcing the electric arc power of the sparking plug. It is the most common fuel saving apparatus in market.

The two above-mentioned conventional technologies have their bottlenecks due to limitations of the characteristics of the fuel itself. To cope with energy crisis, every country in the world has devoted to developing alternative energy engine to adopt other forms of fuel to replace gasoline or diesel, for example hydrogen or alcohol. But the engine technology requires a tremendous change and will not be available commercially in a short time.

Consequently, it is necessary to adopt the other forms of fuel to replace gasoline or diesel in responding energy crisis and overcome the shortcomings of conventional technology which limits itself in the characteristics of fuel. Finally, it can achieve the goals of saving fuel and less environmental pollution.

### SUMMARY OF THE INVENTION

As a result, to solve the shortcomings of above-mentioned conventional technology the main objective of the present invention is to provide a method of fuel conversion for engine and an apparatus of the same. It provides a controller to receive either a signal for actuating the injection fuel nozzle to supply fuel or a signal of a central controller so as to actuate a high voltage generator. The high voltage generator generates a high voltage to boost a high power component of an energy converter. The high power component generates a high energy to ionize the passing fuel mixture into hydrogen and C1˜C4 hydrocarbon combustible gas mixture and feeds into engine chamber. It will reduce fuel loss and enhance engine power to achieve the effect of saving fuel.

Apart from the conventional fuel such as gasoline and diesel can be converted into combustible gas by the present invention, it can convert the edible oil such as vegetable oil, soy bean oil, alcohol group such as alcohol, methanol, ethanol, propyl alcohol, ketone group, various organic solvents or mixture of the above mentioned material into combustible gas. It enables engine to use various kinds of fuel to improve the shortcomings of the above-mentioned conventional technology which can not respond energy crisis to develop an alternative power engine by adopting other forms of fuel in replace of gasoline or diesel.

During the above mentioned energy conversion processes, an adequate amount of pure water H₂O is added as a medium to prevent the carbon deposition phenomenon. It also produces hydrogen and diminishes fuel consumption. It solves the shortcomings of incomplete engine combustion of conventional technology as well as too much CO emission. Finally it achieves the goal of reduce environmental pollution.

During the above mentioned energy conversion processes, when the fuel passes the energy field of high power generated by the high power component of the energy converter it will be ionized into combustible gas mixture of hydrocarbon due to extremely high temperature ionization. It will break the molecular bonds of dioxin to prevent from dioxin generated by incomplete combustion of fuel in engine chamber or other air pollution. Finally it achieves the goal of reducing environmental pollution.

### BRIEF DESCRIPTION OF DRAWINGS

FIG. 1 is a schematic flowchart of the fuel conversion method and apparatus of the same in the present invention.

### DETAILED DESCRIPTION OF THE INVENTION

The other advantage, objective, technical feature and effectiveness of the present invention will be better understood by the detail description of preferred embodiment in conjunction with the following figure.

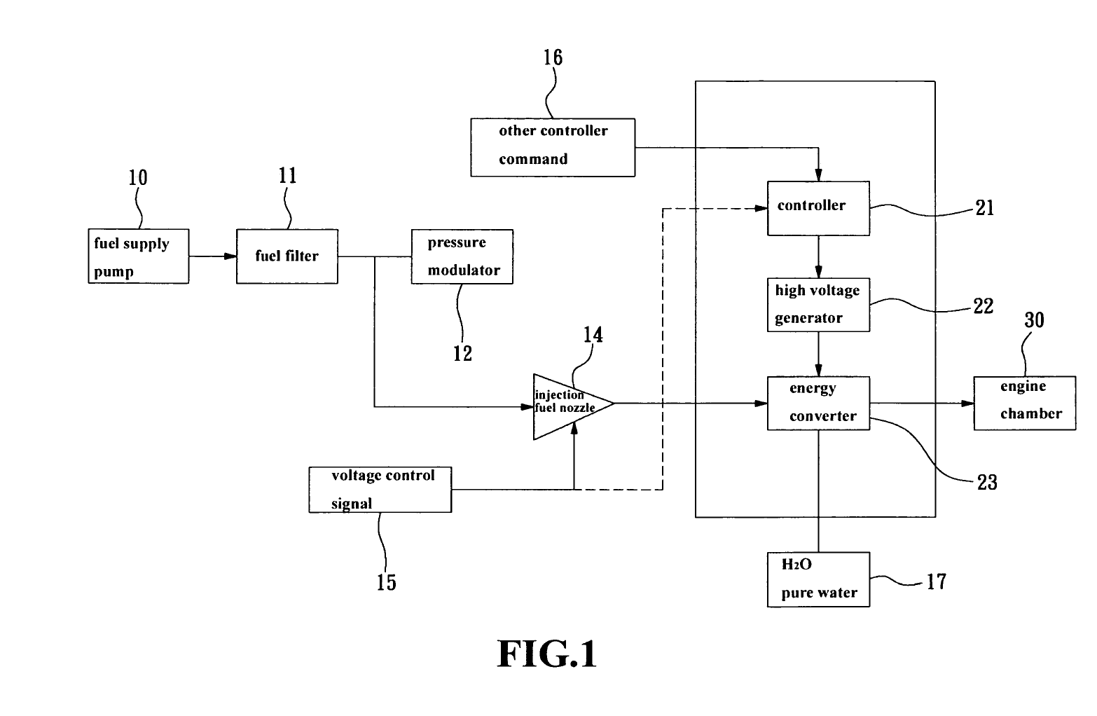

Referring FIG. 1 is a flow chart of a method of fuel conversion and the apparatus of the same in the present invention. It relates to a method of fuel conversion for engine and the device of the same, comprising of: a fuel supply pump 10 to transmit fuel through a fuel filter 11 to a injection fuel nozzle 14, by way of a pressure modulator 13 to adjust the injection fuel pressure of the injection fuel nozzle; an engine control system actuating the injection oil nozzle 14 to open and send a fuel supply signal by an voltage control signal 15; a controller 21 receiving either the fuel supply signal of the injection fuel nozzle 14 or a signal of a central controller to actuate a high voltage generator 22 to produce a high voltage, such a high voltage being transmitted to an energy converter 23 to boost a high power component of an energy converter 23 by means of discharge mode (for example it can utilize electrode discharge to generate a high power electric arc field or utilize a laser component to produce a high power laser pulse energy field etc); furthermore while the injection fuel nozzle 14 injects fuel, an adequate amount of H₂O pure water 17 being mixed and fed into the energy converter 23; when the mixture of H₂O pure water 17 and fuel passes the high energy field generated by the high power component, it being ionized into combustible gas mixture of hydrogen and C1˜C4 hydrocarbon and producing pressure to feed the inflated combustible gas mixture caused by heating through a combustible gas pipeline into a engine chamber 30. It diminishes the loss of fuel and enhances the engine power to achieve the goal of saving fuel.

When the fuel mixture passes the high energy field generated by the high power component, the molecules of fuel will be broken off to become the form of CnHm gas with short molecular bond. The excessive carbon will react with H₂O pure water to form H₂ and CO.

The controller 21 mainly receives a fuel injection control signal or a command of a central controller 16 (for example the direct command signal of an engine central controller) to generate a series of chain reaction. The chain reaction includes: controlling the high voltage generator 22 to generate a high voltage and controlling the high voltage generation sequence in response of oil injection sequence; detecting the concentration and composition of the ionized combustible gas mixture to adjust the output amplitude of the high voltage generator 22 to control the energy field intensity generated by the high power component; controlling the mixed proportion of H₂O pure water 17 to achieve the optimal fuel water mixture ratio.

The high voltage generator 22 is an electronic circuit used to generate a high voltage to boost the high power component of the energy converter 23 to generate a high energy field.

The energy converter 23 mainly generates a high power energy field by the high power component (for example it includes but not limit to an electrode generating an electric arc or a laser component producing a laser pulse energy field or a device generating discharge without oxygen) to rapidly ionize fuel molecules.

While the injection fuel nozzle 14 injects fuel, an adequate amount of H₂O pure water 17 is added and fed into the energy converter chamber 23. H₂O pure water 17 is used to ionize the fuel completely in order not to generate carbon deposition. There are several ways to add H₂O pure water 17 as following. Firstly, it is mixed inside the energy converter 23. Secondly, before the injection fuel nozzle supplies fuel water and fuel are mixed, then fed into the energy converter 23. Thirdly, it utilizes fuel with a constant proportion of water, for example 92% alcohol.

In the preferred embodiment of the present invention the high power component of the energy converter 23 generates high energy. When the fuel mixture of H₂O pure water 17 and fuel passes through the high energy field generated by the high power component, it is ionized into combustible gas mixture of hydrogen and C1˜C4 hydrocarbon as a result of extremely high temperature ionization and fed directly into the engine chamber through a combustible gas pipeline. It diminishes the loss of fuel and enhances engine power to achieve the goal of saving fuel.

In addition to the conventional fuel of gasoline or diesel can be converted into combustible gas by the present invention, the edible oil (for example vegetable oil, soy bean oil, etc), alcohol group (for example alcohol, methanol, ethanol, propyl alcohol, etc), ketone group, various kinds of organic solvent or a mixture of above mentioned material can be converted into combustible gas. It enable engine to utilize various kinds of fuel.

The present invention improves the issues that conventional technology can not develop an alternative power engine to cope with energy crisis by adopting other forms of fuel in replace of gasoline or diesel.

To sum up, the present invention has the following advantages. Firstly, the combustible gas mixture of hydrogen and C1˜C4 hydrocarbon can extend the product life of sparking plug for the reason that the combustion rate of combustible gas is three to ten times rapid of fuel and the hydrogen of combustible gas has high degree of self ignition and enhances engine power substantially. As a result, it achieves the goals of saving fuel with low fuel consumption and high power output.

Secondly, during the above-mentioned energy conversion, when the fuel passes through the high energy field generated by the high power component of the energy converter it will be ionized into combustible gas mixture of hydrocarbon due to extremely high temperature. It will break off the molecule bonds of dioxin to prevent from dioxin produced by incomplete combustion of fuel in the engine chamber or other air pollution. As a result, it achieves the goal of diminishing environmental pollution.

Thirdly, the present invention does not need to modify the configuration of conventional engine. It merely installs the present invention between injection fuel nozzle and engine to receive the control signal of injection fuel nozzle or be commanded by the central processor in the engine to produce moderate high energy field to converter the fuel into combustible gas. It achieves the advantage of saving fuel without modifying engine.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

| | |
|---|---|
| 10 | fuel supply pump |
| 11 | fuel filter |
| 12 | pressure modulator |
| 14 | injection fuel nozzle |
| 15 | voltage control signal |
| 16 | other controller command |
| 17 | H₂O pure water |
| 21 | controller |
| 22 | high voltage generator |
| 23 | energy converter |
| 30 | engine chamber |

What is claimed is:

1. A method of fuel conversion for engine, substantially comprising the steps of:
(a) an fuel supply pump being used to transmit fuel through an fuel filter to an injection fuel nozzle, modulating the injection fuel pressure by means of a pressure modulator, and an engine control system operating the actuation of the injection fuel nozzle by a voltage control signal;
(b) a controller being used to receive either the fuel supply signal for the actuation of the injection fuel nozzle or a central controller signal to actuate a high voltage generator to produce a high voltage;
(c) the said high voltage boosting a high power component of a energy converter by means of a discharge mode;
(d) when the said injection fuel nozzle being actuated to supply fuel adequate amount of H₂O pure water is fed into the energy converter;
(e) the said high power component generating a high power energy field to ionize the passing fuel mixture of H₂O pure water and fuel into combustible gas mixture;
(f) a pressure being generated during the said ionization process to have the combustible gas mixture inflate by heating and feeding directly into engine to generate power by means of a combustible gas pipeline.

2. A method of fuel conversion for engine according to claim 1, wherein in step (e) the fuel molecules are broken off to become CnHm form gas with short molecular bond as a result of extremely high temperature ionization, the excessive carbons react with H₂O pure water to become H₂ and CO.

3. A method of fuel conversion for engine according to claim 1, wherein the high power component of step (e) is at least an electrode which generates a high power electric arc field by discharging.

4. A method of fuel conversion for engine according to claim 1, wherein the high power component of step (e) is a laser component which generates a high power laser pulse energy field by excitation.

5. A method of fuel conversion for engine according to claim 1, wherein the H₂O pure water is used to ionize the fuel completely in order not to form carbon deposition phenomenon and generates hydrogen.

6. A method of fuel conversion for engine according to claim 5, wherein the way of adding H₂O pure water is to mix in the energy converter.

7. A method of fuel conversion for engine according to claim 5, wherein the way of adding H₂O pure water is to mix H₂O pure water and fuel before the injection fuel nozzle supplies fuel, then feeds into the energy converter.

8. A method of fuel conversion for engine according to claim 5, wherein the way of adding H₂O pure water is to directly use fuel having a constant ratio of H₂O pure water such as 92% alcohol.

9. A method of fuel conversion for engine according to claim 1, wherein the gas mixture contains hydrogen and C1˜C4 hydrocarbon.

10. A method of fuel conversion for engine according to claim 1, wherein the controller generates a series of chain reactions after receiving a signal, comprising the steps of:
(a) controlling the high voltage generator to generate high voltage and controlling high voltage generation sequence in response of fuel injection sequence;
(b) detecting the concentration and composition of ionized gas mixture to modulate the output intensity of the high voltage generator to control the energy field intensity generated by the high voltage component;
(c) controlling the mixture ratio of the H₂O pure water to achieve the optimal ratio of fuel and water.

11. A apparatus of fuel conversion for engine using the method as set forth in claim 1, comprising of:
(a) a controller which receives either an actuating fuel supply signal of the injection fuel nozzle or a signal of a central controller to have control capability;
(b) a high voltage generator which is controlled by the said controller to produce a high voltage;
(c) an energy converter which receives the discharge mode of the said high voltage boosts a high power component inside to generate high power energy field.

12. A apparatus of fuel conversion for engine according to claim 11, wherein the high power component is at least an electrode which produces high power electric arc field by discharge.

13. A device of fuel conversion for engine according to claim 11, wherein the high power component is a laser component which generates a high power laser pulse energy field by excitation.

14. A device of fuel conversion for engine according to claim 11, wherein the high voltage generator is constituted by a high voltage electronic circuit to boost the high power component of the energy converter to produce a high power energy field.

15. A device of fuel conversion for engine according to claim 11, wherein the energy converter ionizes fuel molecules rapidly by the high power energy field generated by the high power component.
